(19) United States
(12) Patent Application Publication
(10) Pub. No.: US 2025/0233427 A1
(43) Pub. Date: Jul. 17, 2025

(54) CHARGING DEVICE WITH SMART IOT CONNECTED FEATURES

(71) Applicant: Floyd Lee Washington, Chicago, IL (US)

(72) Inventor: Floyd Lee Washington, Chicago, IL (US)

(21) Appl. No.: 19/023,232

(22) Filed: Jan. 15, 2025

Related U.S. Application Data
(60) Provisional application No. 63/630,205, filed on Jan. 17, 2024.

(51) Int. Cl. H02J 7/00; H01M 10/42; H01M 10/48; H01M 50/24; H01M 50/271

(52) U.S. Cl. CPC H02J 7/00032; H01M 10/425; H01M 10/488; H01M 50/24; H01M 50/271; H02J 7/0048; H01M 2010/4278; H02J 2207/20

(57) ABSTRACT

An improved charging device with Smart IOT connected features is disclosed. The charging device provides AC current to various external devices, including electric vehicles and household appliances. The device includes a portable housing assembly with at least one charging port and an integrated smart battery charger that monitors voltage and current levels. An inverter converts stored DC power into AC power. The LCD touchscreen displays real-time charging status and supports touch activation commands from a mobile communication device for remote operation.

### RELATED APPLICATIONS

This application claims priority to U.S. Provisional Patent Application Ser. No. 63/630,205 filed Jan. 17, 2024, now pending.

### FIELD OF THE INVENTION

An improved charging device with Smart IOT connected features is presented. The device is designed to provide AC current to various external devices, including vehicles and household devices, through at least one charging port integrated into its housing assembly. The system automatically initiates charging upon connection of an electrical device, with an integrated LCD touch screen displaying the charging status of the system.

### BACKGROUND OF THE INVENTION

This disclosure presents an innovative charging device designed to meet the evolving needs of modern users, emphasizing flexibility, portability, and efficiency. The device features a compact design that integrates multiple functionalities, allowing users to charge vehicles, household appliances, and various electronic devices seamlessly.

Key to its versatility is the inclusion of replaceable battery and inverter components, which not only enhance the device's longevity but also empower users to adapt to different power requirements easily. This modular approach addresses a significant gap in the current market, where many charging solutions lack the adaptability to cater to diverse electrical needs.

The device's Smart IOT capabilities enable real-time monitoring and management of charging processes, making it a necessary advancement in the art of power supply technology. By providing a user-friendly interface that displays charging status and other vital information, this invention sets a new standard for efficiency and convenience in energy management.

Moreover, the compact design ensures that the device can be easily transported and utilized in various settings, further enhancing its practical application in both domestic and automotive environments. This innovation not only underscores the demand for multifunctional charging solutions but also reflects a commitment to advancing the accessibility and effectiveness of power supply technologies in today's fast-paced world.

To this end, an improved charging device with Smart IOT connected features for sequentially providing AC current to an external device is presented. The charging device includes a removable cover, a front side having at least one charging port electrically connected to at least one inverter for supplying the AC current to an external device, and an integrated LCD touch screen in wired and wireless communication with a mobile communication device. The improved charging device is further characterized with the following novel features: (1) At least one smart battery charger that is configured to monitor voltage and current levels of a battery is connected to a battery and to an inverter and the battery being connected to the inverter for converting the DC power into AC power for intermittent charging of an external device; (2) The front side of the charging system having a control unit including a microprocessor having a method of establishing communication between the charging system, the integrated LCD touch screen, and mobile communication device; (3) One or more custom-programmed software and databases configured to be executed by the microprocessor and the microprocessor having multiple inputs for receiving encoded touch signals including at least a first and a second encoded touch signal; (3) The LCD touch screen having a user interface for monitoring the established supply of DC Current, battery life, the power status of the inverter, and a specified wireless signal range in communication with at least one computer system of the remote access device; (4) The front side of the charging device having a switching circuit electrically connected to the inverter for converting the DC power into AC power for intermittent charging of the external device.

### SUMMARY

This disclosure pertains to an improved charging device designed to efficiently supply AC current to a range of electrical devices, including vehicles and household appliances. The device comprises a fully enclosed and portable housing assembly, which incorporates at least one charging port located on the front side, facilitating direct connection for charging applications.

The charging device features a housing assembly removably housing a smart battery charger that is configured to monitor the voltage and current levels of a connected battery, an inverter that enables versatile charging capabilities for various applications, and an integrated LCD touch screen serving as the user interface, providing real-time feedback on the charging status of the battery and the power status of the inverter. The design includes components that allow for the easy replacement of the charger, battery and inverter, addressing the need for adaptability and longevity in power supply solutions.

The design of the charging device ensures portability, making it suitable for both residential and automotive environments. By integrating advanced IOT features with user-friendly controls, this invention offers a comprehensive and efficient solution for energy management, thereby fulfilling an essential need in the current market for multifunctional charging devices.

Unless otherwise defined, all technical and scientific terms used herein have the same meaning as commonly understood by one of ordinary skill in the art. Although methods and materials similar or equivalent to those described herein can be used in the practice or testing of any described embodiment, suitable methods and materials are described below. In addition, the materials, methods, and examples are illustrative only and not intended to be limiting.

In case of conflict with terms used in the art, the present specification, including definitions, will control. The foregoing summary is illustrative only and is not intended to be in any way limiting. In addition to the illustrative aspects, embodiments, and features described above, further aspects, embodiments, and features will become apparent by reference to the drawings and the following detailed description and claims.

### BRIEF DESCRIPTION OF THE DRAWINGS

The present embodiments are illustrated by way of the figures of the accompanying drawings, which may not necessarily be to scale, in which like references indicate similar elements, and in which:

FIG. 1 is a perspective illustrating the removable cover being removed from the charging device;

FIG. 2 is a rear view of the charging device showing the vertical flow and configuration of the inverter, battery, and smart charger as provided herein;

FIG. 3 is a perspective view illustrating the front side of the charging device as provided herein;

FIG. 3 is a block diagram of the charging device described herein;

FIG. 4 is a side view of the charging device described herein;

FIG. 5 is a flow chart of a method of recharging a battery and converting DC power to AC power according to an embodiment described herein;

FIG. 6 is a block diagram delineating the status pathway of the smart charger and the inverter within the mobile application;

FIG. 7 is a block diagram of a method for recharging the battery and delineating the status pathway of the smart charger within the mobile application; and

FIG. 8 is a block diagram delineating the status pathway of the smart charger and the inverter within the mobile application for charging an external device.

### DETAILED DESCRIPTION

The following detailed description is a contemplated mode of carrying out a charging device 10 with Smart IOT connected features as provided herein. Although the device 10 and method are explained in relation to an illustrated embodiment, it is understood that many possible modifications and variations can be made without departing from the spirit and scope of the disclosure.

It can be appreciated that implementation of a charging device 10 with Smart IOT connected features can include user devices capable of displaying a graphical user interface from a computer system.

The charging device 10 may be used on various types of vehicles 26 including battery electric vehicles (BEVs), Plug-in vehicles, ultra low-emission vehicles, range extended vehicles, hybrid vehicles and with charge connection devices provided in accessible areas of a vehicle including placement on rear hatches, hoods, rear bumpers, front sides, or as desired by a manufacturer.

The improved charging device 10 is designed to provide AC current to a diverse array of systems that may require portable power solutions. This includes a plurality of brands and models of electric vehicles, such as sedans, SUVs, and trucks, all of which benefit from the device's 10 ability to deliver reliable charging capabilities. Additionally, the device 10 can power various types of equipment and appliances, ranging from power tools and outdoor machinery to recreational vehicles, motorcycles, and marine applications. Its versatility extends to supporting systems in both residential and commercial environments, where temporary power is needed for events, construction sites, or emergency situations. By accommodating a wide range of electrical devices, the charging device 10 addresses the growing demand for flexible and efficient power solutions in today's increasingly electrified landscape.

The housing assembly 12 of the improved charging device 10 may be constructed from a variety of durable materials known in the prior art, including but not limited to high-impact plastic, aluminum, stainless steel, reinforced composites and the same for ensuring that the housing assembly 12 will withstand rigorous use while maintaining portability. The portability embraces a variety of design features that facilitate movement to different locations as needed. The housing assembly 12 can be equipped with multiple transport mechanisms, such as integrated handles or straps, enabling users to easily carry the device 10 to areas where electric vehicles require recharging or to locations outside a home for powering household appliances. Additionally, the device's 10 lightweight construction and compact design allow for convenient relocation, whether it is positioned in a garage, on a driveway, or in outdoor settings. This versatility in portability ensures that the charging device 10 can adapt to a wide range of applications, meeting the user's energy needs in diverse environments while enhancing usability and convenience.

The charging device 10 can be constructed in various sizes and configurations to accommodate a range of applications, particularly concerning the base 22 and locking mechanisms of the removable cover 14. While the design drawings illustrate the removable cover 14 as being affixed to the left 34 and right side surfaces 36 of the front side 26, alternative configurations are also feasible. For instance, the removable cover 14 may be designed to operate in a slidable manner, allowing for straightforward access and secure attachment. Additionally, unique locking mechanisms can be implemented to enhance the user experience, such as sliding, snap-fit, or hinged designs. This adaptability in design not only facilitates ease of use but also allows the charging device 10 to be tailored to specific user needs and aesthetic preferences, promoting versatility and functionality across a wide range of contexts.

The smart battery charger 48 integrated into the improved charging device 10 can be utilized to charge batteries of varying capacities, enabling the system to achieve at least one predetermined charging threshold suitable for a range of external devices 11. This versatility allows for the use of different types of smart battery chargers 48 tailored to specific applications, such as rapid chargers for electric vehicles, trickle chargers for maintaining motorcycle batteries, or intelligent chargers designed for lithium-ion batteries used in electric bikes.

Given the portable nature of the device 10, the configuration can be more efficient than using separate chargers or power sources for the inverter 32 and the battery 52. It allows for a centralized charging system that can optimize the charging process based on the state of the battery 52. The charger 48 monitors the battery 52 health to prevent overcharging. It maintains the battery charge level, preventing deep discharge, which can damage the batteries. The smart charger 48 can be designed in various sizes and configurations to enhance mobility and ease of use. For instance, compact chargers may be incorporated for lightweight applications, while more robust chargers are suitable for larger battery systems, such as those found in trucks or recreational vehicles. The modular design allows users to select and replace chargers based on their specific needs, ensuring compatibility with a wide range of battery types and sizes.

Therefore, the charging device 10 may be used to recharge various types of rechargeable batteries having a plurality of energy storage systems, traction battery packs, varied battery chemistries, capacities, conversion methods, electric architecture, enclosures, planar cells, vehicle performance needs, and the same to provide the electric needs of an external device 11. There are well know charging levels and methods including direct current (DC) fast charging, alternating current (AC) Level 1 up to 1.92 Kilowatts (KW), AC Level 2 up to 19.2 KW, DC Level 1 up to 48 KW, DC level 2 up to 400 KW and similar adjustable charging levels that would be applicable to the rechargeable battery 52 described herein.

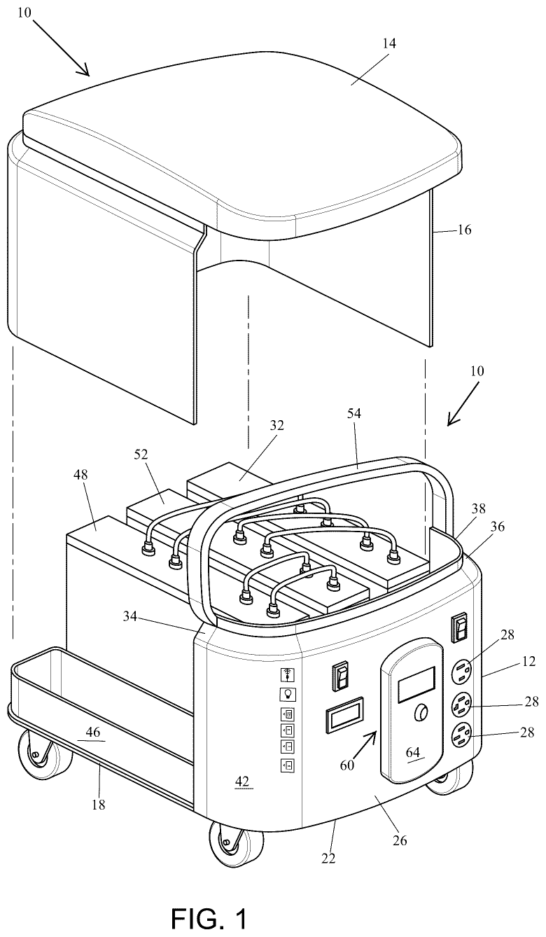

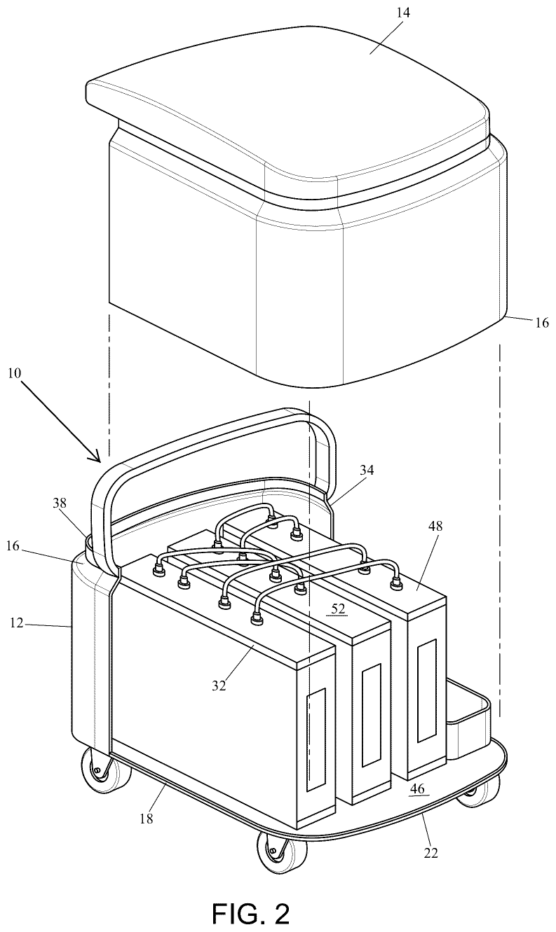

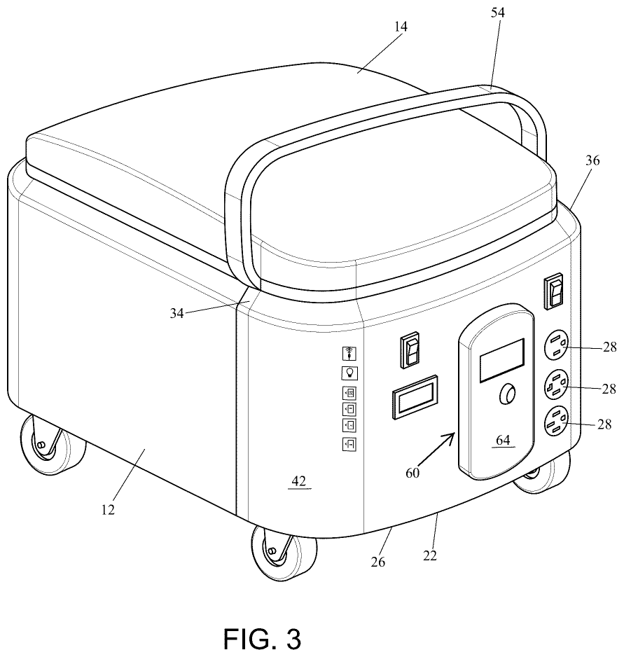

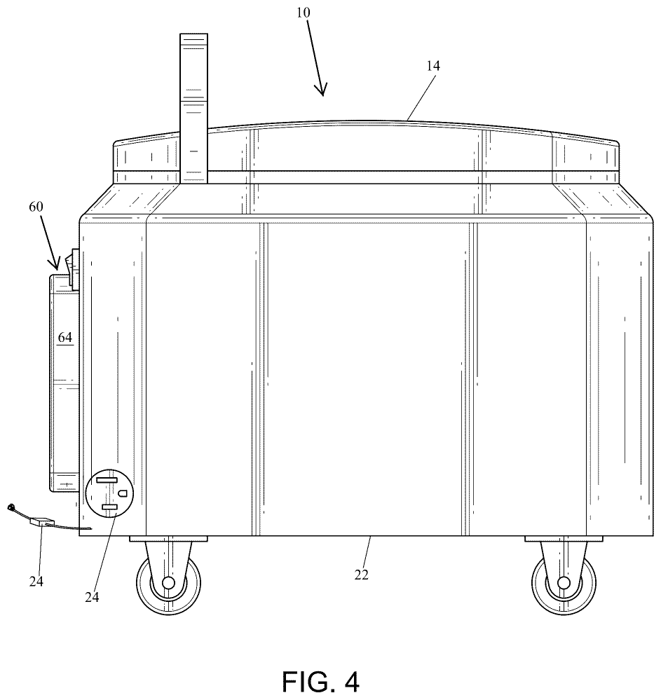

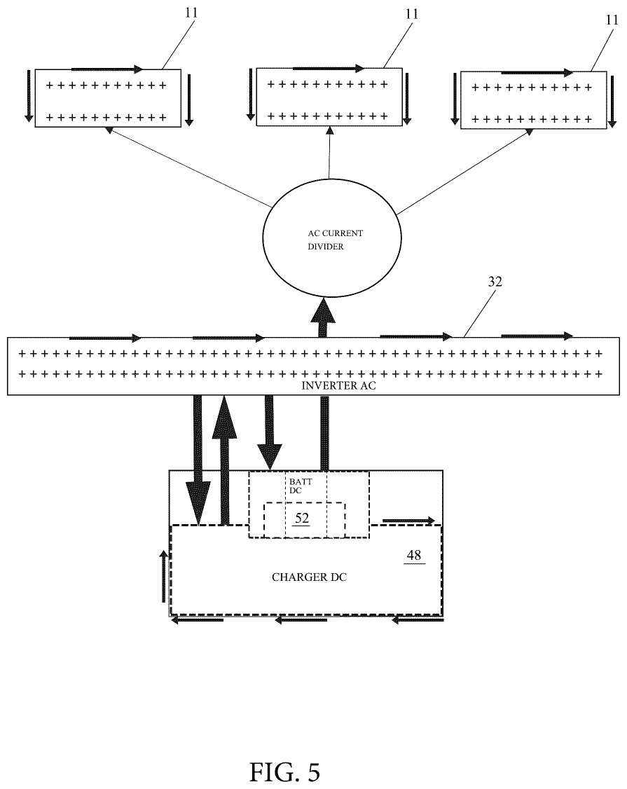

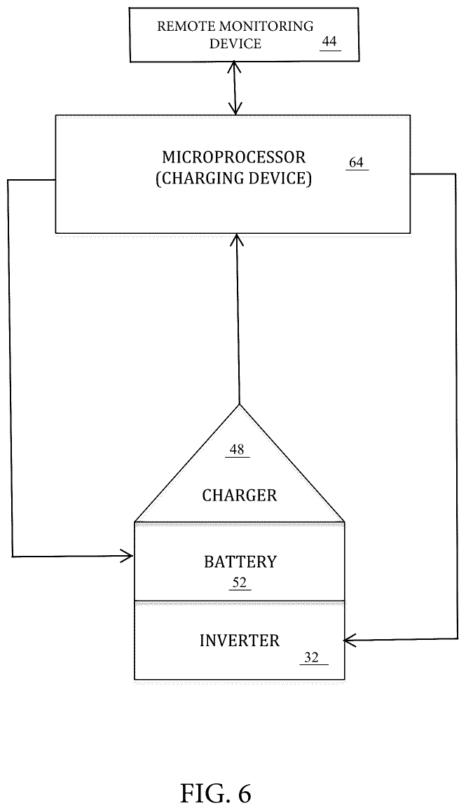

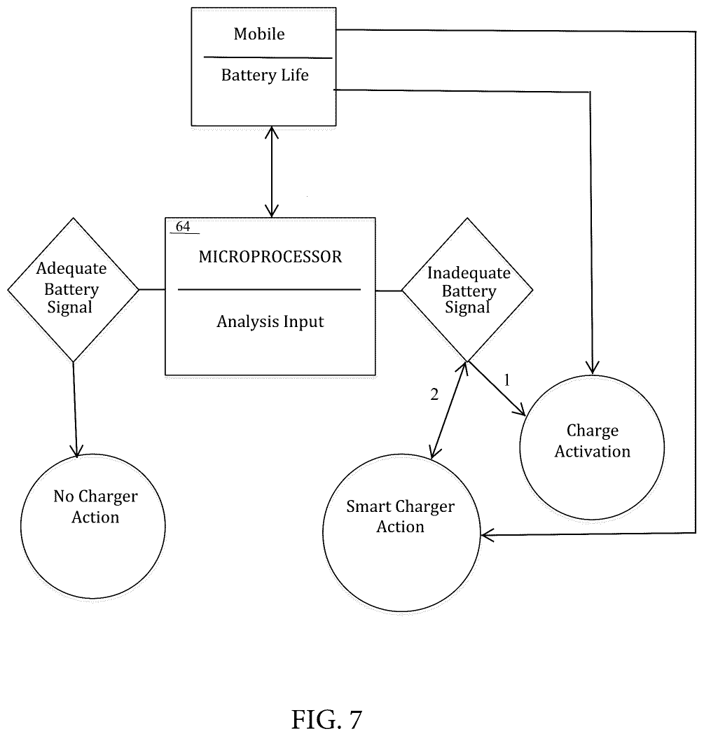

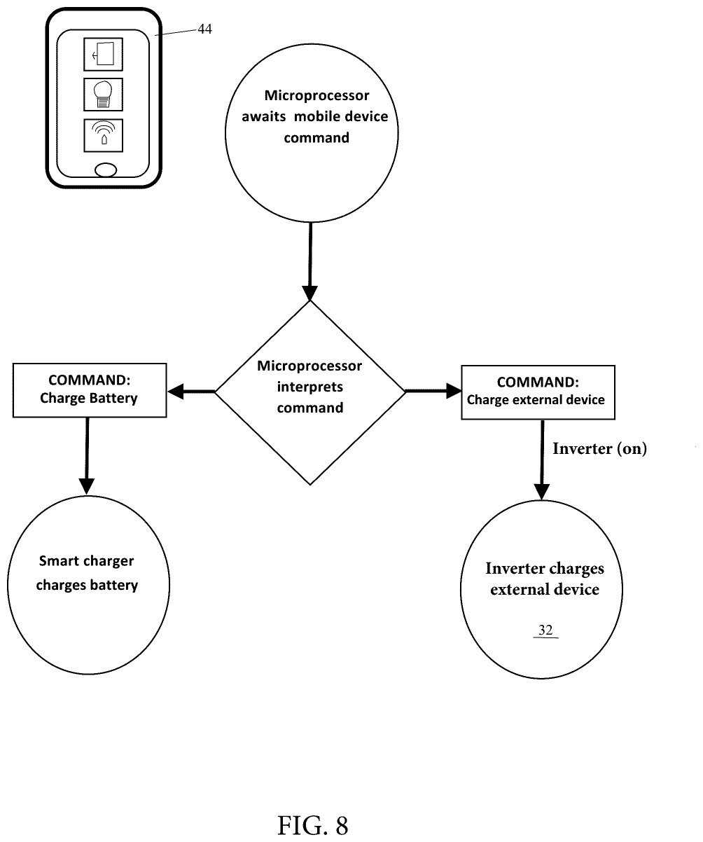

Referring now to FIGS. 1-8, the method of providing an improved charging device 10 with Smart IOT connected features for sequentially providing AC current to an external device 11 according to one embodiment of the present disclosure includes the charging device 10 further comprising a fully enclosed and portable housing assembly 12 having a removable cover 14 with mating threads 16 that are associated to the lock fit edge 18 of a base 22 for receiving the same thereon, electrical connection 24 for connecting the housing 12 to an external electrical circuit, a front side 26 having at least one charging port 28 electrically connected to at least one inverter 32 for supplying the AC current to the external device 11, a left outer surface 34, a right outer surface 36, a lock fit top edge 38, and an integrated LCD touch screen in wired and wireless communication with a mobile communication device 44, and an interior space 46 for removably housing electrical connections therein for connection to a charging system. The interior space 46 houses at least one smart battery charger 48 configured to monitor voltage and current levels of a connected battery that is simultaneously connected to at least one battery 52 with stored DC power and to the inverter 32 and the battery 52 being connected to the inverter 32 for converting the DC power into AC power for intermittent charging of the external device 11.

The removable cover 14 is provided with a transport mechanism for removing the same from the housing 12 and for transporting the housing 12 and wherein the transport mechanism extends from the left outer surface 34 to the right outer surface 36 of the front side 26 of the housing assembly 12 and extends to a height and in a direction above the front side 26 thereof.

The front side 26 of the charging device 10 features a control unit 60 including a microprocessor 62 having a memory device coupled to the microprocessor. The microprocessor 62 stores instructions adapted to be executed by the microprocessor 62 and the microprocessor 62 having a method of establishing communication between the charging device 10, the integrated LCD touch screen 42, and a mobile communication device 44.

One or more custom-programmed software and databases are stored in the memory device and are configured to be executed by the microprocessor 62, the one or more custom-programmed software and databases include the microprocessor 62 having multiple inputs for receiving encoded touch signals including at least a first and a second encoded touch signal. The first encoded touch signal being stored in the memory unit, the first encoded touch signal being associated with the start and the end of at least one charging advancement sequence wherein the charger 48 advances to charging of the battery 52 to at least 120 volts and wherein the control unit 60 is configured to advance the charging of the battery 52 in accordance with the at least one charging advancement sequence.

The second encoded signal being stored in the memory unit 60, the second encoded touch signal being associated with the start and the end of providing AC current to an external device 11 wherein the inverter 32 provides AC current to an external device 11 and wherein the computer system is configured to advance the provision of AC current to the external device 11 in accordance with the second encoding signal.

The LCD touch screen 42 having a user interface for monitoring at least a first, a second, and third monitoring indicating the established supply of DC Current, battery life, and the power status of the inverter 32, with a specified wireless signal range in communication with at least one computer system of a remote device. The front side 26 having a switching circuit for the inverter 32 for converting the DC power into AC power for intermittent charging of the external device 11 and the controllable switching circuit for the inverter 32 being responsive to the touch encoded signals.

The microprocessor 62 of the charging device 10 is configured to analyze battery performance data in response to the start and the end of providing AC current to the external device 11. This functionality is activated in response to the initiation and cessation of AC current delivery to the external device 11. The microprocessor 62 continuously monitors key performance metrics, such as voltage levels, current flow, and temperature, allowing it to assess the state of charge and overall health of the connected battery 52. Upon starting the provision of AC current, the microprocessor 62 collects and records performance data, enabling it to determine the efficiency of the charging process and identify any potential issues, such as overheating or abnormal voltage fluctuations. Once the charging process concludes, the control unit 60 performs a comprehensive analysis of the recorded data, generating insights into battery performance, including charge retention and cycle life. This analytical capability not only enhances the safety and reliability of the charging process but also provides users with valuable feedback regarding the condition of their batteries, ensuring informed decision-making for future charging activities. By integrating this advanced monitoring and analytical feature, the charging device 10 significantly improves the user experience and optimizes battery maintenance.

LCD touch screen 42 of the housing assembly 12 is a touch screen recognizing the touch of a finger. Three icons of the LCD touch screen 42 represent a status of the charging device 10 thereby providing real-time feedback to the user. This user-friendly feature facilitates effortless navigation through the device's 10 various functions and settings and may different states of operation, such as “Charging,” “Fully Charged,” and “Fault,” allowing users to quickly ascertain the status of the charging process. For example and without limitation, when the device 10 is actively delivering AC current to an external device 11, the “Charging” icon illuminates, signaling that power is being supplied. Once the charging process is complete, the “Fully Charged” icon activates, providing assurance that the connected battery is at optimal capacity.

The mobile device 44 as provided herein is depicted as a smart phone, but it will be understood that a plurality of mobile devices 44 or any other user device capable of displaying a graphical user interface may be utilized for utilizing the charging device 10 as provided herein. Examples as provided herein may include, but are not limited to, smart watches, laptops, tablets, personal computers, televisions, fitness trackers, and the same for implementation of the method of charging external devices 11 as provided herein.

The mobile communication device 44 associated with the charging device 10 facilitates remote interaction through touch activation commands, allowing users to control the charging process from a location away from the device 10. This functionality is not confined to close proximity; rather, it can operate effectively over significant distances, enabling users to initiate, monitor, and modify charging activities without needing to be physically present at the device 10.

In addition to touch activation, the system can be designed to support voice activation commands, thereby providing users with a hands-free option for managing their charging needs. This versatility can allow for a variety of commands, such as starting or stopping the charging process, checking battery status, or adjusting settings, all of which can be executed through simple voice instructions. By incorporating a plurality of activation capabilities, the charging device 10 would enhance user convenience and accessibility, catering to diverse preferences and scenarios in diverse environments including indoor spaces, outdoor spaces or the same to facilitate the remote operation of the charging device 10.

In a preferred embodiment, a scaled battery that is designed to optimize performance while meeting the varying power demands of connected devices can be used. However, various types of lithium, lead, nickel, sodium, or solid state batteries can be used if the usage would address the efficiency, portability, and compact need of the charging device 10. Within the interior space 46 of the housing assembly 12, the charger 48, battery 52, and inverter 32 are vertically arranged to maximize efficient use of space and facilitate easy access for maintenance and replacement. This configuration allows users to effortlessly remove and replace these components as needed, ensuring the device 10 remains adaptable to changing power requirements.

The removable cap of the housing assembly 12 seals the housing 12 to create a watertight barrier. This design prevents exposure to environmental elements and restricts movement of the charger 48, battery 52, and inverter 32 during transport and operation, thereby enhancing the overall durability and reliability of the device 10. The charger 48, battery 52, and inverter 32 replaceable, thereby allows users to maintain optimal functionality and extend the lifespan of the charging device 10. This modular approach not only promotes ease of use but also underscores the invention's commitment to providing a versatile and long-lasting power solution.

Certain components necessary to the operation of this disclosure are not shown or described in detail because they are components well known to those in the relevant arts. These components can include requisite modules, dashboards, devices, databases, and similar components.

While the invention has been described in detail and with reference to specific embodiments thereof, it will be apparent to one skilled in the art that various changes and modifications can be made therein without departing from the spirit and scope thereof.

What is claimed is:

1) An improved charging device with Smart IOT connected features for sequentially providing AC current to an external device, the charging device further comprising,
a fully enclosed and portable housing assembly having a removable cover with mating threads that are associated to the lock fit edge of a base for receiving the same thereon; electrical connection means for connecting the housing to an external electrical circuit; a front side having at least one charging port electrically connected to at least one inverter for supplying the AC current to the external device, a left outer surface, a right outer surface, a lock fit top edge, and an integrated LCD touch screen in wired and wireless communication with a mobile communication device, and an interior space for removably housing electrical connections therein for connection to a charging system wherein at least one smart battery charger configured to monitor voltage and current levels of a connected battery is simultaneously connected to at least one battery with stored DC power and to the inverter and the battery being connected to the inverter for converting the DC power into AC power for intermittent charging of the external device;
wherein the removable cover is provided with a transport mechanism for removing the same from the housing and for transporting the housing and wherein the transport mechanism extends from the left outer surface to the right outer surface of the front side of the housing assembly and extends to a height and in a direction above the front side thereof;
the front side of the charging device having a control unit including a microprocessor having a memory device coupled to the microprocessor, the microprocessor storing instructions adapted to be executed by the microprocessor, the microprocessor having a method of establishing communication between the charging device, the integrated LCD touch screen, and a mobile communication device;
one or more custom-programmed software and databases, wherein the one or more custom-programmed software and databases are stored in the memory device and are configured to be executed by the microprocessor, the one or more custom-programmed software and databases include the microprocessor having multiple inputs for receiving encoded touch signals including at least a first and a second encoded touch signal;
the first encoded touch signal being stored in the memory unit, the first encoded touch signal being associated with the start and the end of at least one charging advancement sequence wherein the charger advances to charging of the battery to at least 120 volts and wherein the control unit is configured to advance the charging of the battery in accordance with the at least one charging advancement sequence;
the second encoded signal being stored in the memory unit, the second encoded touch signal being associated with the start and the end of providing AC current to an external device, wherein the inverter provides AC current to an external device and wherein the microprocessor is configured to advance the provision of AC current to the external device in accordance with the second encoding signal,
The LCD touch screen having a user interface for monitoring at least a first, a second, and third monitoring indicating the established supply of DC Current, battery life, and the power status of the inverter, with a specified wireless signal range in communication with at least one computer system of a remote device,
the front side having a switching circuit for the inverter for converting the DC power into AC power for intermittent charging of the external device, the controllable switching circuit for the inverter being responsive to the touch encoded signals.

2) A method of providing an improved charging device with Smart IOT connected features for sequentially providing AC current to an external device, the method comprising the steps of,
providing a fully enclosed and portable housing assembly having a removable cover with mating threads that are associated to the lock fit edge of a base for receiving the same thereon, providing electrical connection means for connecting the housing to an external electrical circuit, providing a front side having at least one charging port electrically connected to at least one inverter, a left outer surface, a right outer surface, a lock fit top edge, and an integrated LCD touch screen in wired and wireless communication with a mobile communication device, and an interior space for removably housing electrical connections therein for connection to a charging system wherein at least one smart charger configured to monitor voltage and current levels of a connected battery is simultaneously connected to at least one battery with stored DC power and to the inverter and the at least one battery being connected to the inverter for converting the DC power into AC power for intermittent charging of the external device;
equipping the removable cover with a transport mechanism for removing the same from the housing and for transporting the housing and extending the transport mechanism from the left outer surface to the right outer surface of the front side of the housing assembly and extending the transport mechanism to a height and in a direction above the front side of the housing assembly;
providing the front side of the charging device with a control unit including a microprocessor having a memory device coupled to the microprocessor, the microprocessor storing instructions adapted to be executed by the microprocessor, the microprocessor having a method of establishing communication between the charging device, the integrated LCD touch screen, and a mobile communication device;
providing one or more custom-programmed software and databases, wherein the one or more custom-programmed software and databases are stored in the memory device and are configured to be executed by the microprocessor, the one or more custom-programmed software and databases include the microprocessor having multiple inputs for receiving encoded touch signals including at least a first and a second encoded touch signal;
storing the first encoded touch signal in the memory unit, the first encoded touch signal being associated with the start and the end of at least one charging advancement sequence wherein the charger advances to charging of the battery to at least 120 volts and wherein the microprocessor is configured to advance the charging of the battery in accordance with the at least one charging advancement sequence;
storing the second encoded touch signal in the memory unit, the second encoded touch signal being associated with the start and the end of providing AC current to the external device wherein the inverter provides AC current to the external device and wherein the microprocessor is configured to advance the provision of AC current to the external device in accordance with the second encoding signal;
providing the LCD touch screen with a user interface for monitoring at least a first, a second, a third, and a fourth monitoring indicating the established supply of DC Current, battery life, inverter power status, and a specified wireless signal range in communication with at least one computer system of a remote device,
providing the front side with a switching circuit for the inverter for converting the DC power into AC power for intermittent charging of the external device, the controllable switching circuit for the inverter being responsive to the touch encoded signals.

3) The charging device of claim 1 wherein the charger of the charging device is configured to analyze battery performance data in response to the start and the end of providing AC current to the external device.

4) The housing assembly of claim 1 wherein the LCD touch screen of the housing assembly is a touch screen recognizing the touch of a finger.

5) The LCD touch screen of claim 1 wherein the icons of the LCD touch screen represent a status of the charging device.

6) The charging device of claim 1, wherein the mobile communication device of the charging device is a mobile device.

7) The charging device of claim 1, wherein the mobile communication device of the charging device provides the touch activation command from a remote location away from the charging device.

8) The charging device of claim 1, wherein the battery of the charging device is a scaled battery.

9) The charging device of claim 1, wherein the charger, battery, and inverter of the charging device are vertically arranged and removably placed in the interior space of the housing assembly.

10) The housing assembly of claim 1 wherein the removable cap of the housing assembly seals the housing during use to form a watertight seal that prevents exposure and movement of the charger, battery, and inverter.
